(19) United States
(12) Patent Application Publication
(10) Pub. No.: US 2020/0249486 A1
(43) Pub. Date: Aug. 6, 2020

(54) INCORPORATION OF A PROJECTED FILTERED RETICLE INTO AN OBSERVATIONAL DEVICE OR RIFLESCOPE

(71) Applicant: Meopta U.S.A., Inc., Trinity, FL (US)

(72) Inventor: Philip E. Buchsbaum, Oldsmar, FL (US)

(21) Appl. No.: 16/778,076

(22) Filed: Jan. 31, 2020

Related U.S. Application Data
(60) Provisional application No. 62/799,081, filed on Jan. 31, 2019.

(51) Int. Cl. G02B 27/01; F41G 1/38

(52) U.S. Cl. CPC G02B 27/0189; G02B 27/0172; F41G 1/38

(57) ABSTRACT

A system that projects a specifically filtered Heads-Up Display or some other form of display or illuminating device created reticle onto one of the specifically coated focal points of an observational device or riflescope. The reticle producing Heads-Up Display is filtered with a thin film coating limiting the spectral emission of the display to the transmission specification of the coating. A second coating with a reflectivity corresponding to the filter coating's transmission is placed on the focal plane upon which the Heads-Up Display reticle is to be projected. The reflective coating can be placed on, but not limited to, the reticle displaying surface of the optical device is disclosed.

### CROSS-REFERENCE TO RELATED APPLICATION

The present application claims the benefit of previously filed co-pending Provisional Patent Application Ser. No. 62/799,081, filed on Jan. 31, 2019.

### FIELD OF THE INVENTION

The system of this disclosure belongs to the field of aiming systems. More specifically it is a system that projects a specifically filtered Heads-Up Display (or some other form of display or illuminating device) created reticle onto one of the specifically coated focal points of an observational device or riflescope. The reticle producing Heads-Up Display is filtered with a thin film coating limiting the spectral emission of the display to the transmission specification of the coating. A second coating with a reflectivity corresponding to the filter coating's transmission is placed on the focal plane upon which the Heads-Up Display reticle is to be projected. The reflective coating can be placed on, but not limited to, the reticle displaying surface of the optical device.

### BACKGROUND OF THE INVENTION

In a typical prior art Heads-Up Display (HUD) for an automobile the display is projected onto the windshield. The automobile's windshield is glass reflecting 4% of the light back into the automobile resulting in the display appearing to be projected onto the windshield.

The invention of this disclosure takes a HUD projected display and filters it to a very specific wavelength resulting in a much more efficient system.

Thus there's the need for the novel approach of this disclosure that greatly increases the efficiency of a Heads-Up Display, or some other form of display or illuminating device, onto one of the focal points of an observational device or riflescope.

### BRIEF SUMMARY OF THE INVENTION

What is disclosed is a system that projects a specifically filtered projected Heads-Up Display (or some other form of display or illuminating device) created reticle onto one of the specifically coated focal points of an observational device or riflescope. The reticle producing Heads-Up Display is filtered with a thin film coating limiting the spectral emission of the projected display to the transmission specification of the coating. A second coating with a reflectivity corresponding to the filter coating's transmission is placed on the focal plane upon which the Heads-Up Display reticle is to be projected. The reflective coating can be placed on, but not limited to, the reticle displaying surface of the optical device.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a general concept exploded diagram of the filtered projected reticle system of this disclosure incorporated into a reflex sight.

### DESCRIPTION OF THE PREFERRED EMBODIMENT

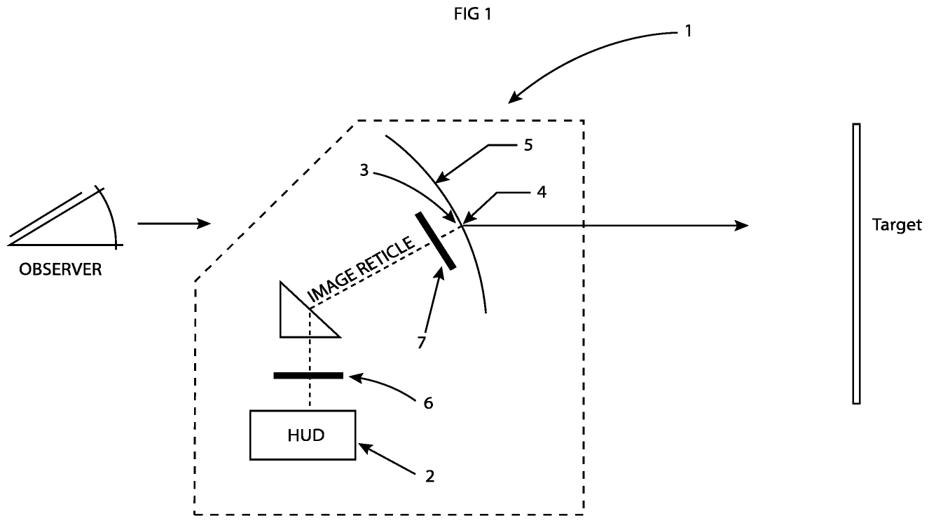

As discussed above and as shown in the exploded diagram reflex sight of FIG. 1 the filtered projected reticle system (1) for an aiming device of this disclosure is more efficient. It is a filtered projected reticle system (1) that projects a specifically filtered Heads-Up Display (2) (or some other form of display or illuminating device) created reticle (3) onto one of the specifically coated focal points (4) on the focal plane (5) of an observational device or riflescope. The reticle (3) producing Heads-Up Display (2) is filtered with a HUD (2) thin film coating filter (6), shown separated from the HUD for ease of illustration purposes, limiting the spectral emission of the projected display to the transmission specification of the coating. Also, a focal plane (5) thin film filter coating (7), shown separated from the focal plane (5) for ease of illustration purposes, with a reflectivity corresponding to the HUD (2) thin film filter (6) coating's transmission is placed on the focal plane (5) upon which the HUD (2) reticle (3) is to be projected. The reflective coating can be placed on, but not limited to, the reticle (3) displaying surface, focal plane (5), of the optical device.

More specifically this filtered projected reticle system (1) takes the projected display and filters it to a very specific wavelength. The focal points (4) on the focal plane (5) upon which the Heads-Up Display (2) of an observational device or riflescope's reticle (3) is to be projected is also coated with a 99% reflective film for that same wavelength. The filtered projected reticle system (1) then becomes much more efficient than a similar unfiltered one since 99% of the light is being reflected back to the observers verses 4% in the typical prior art system as discussed above. The drawback is that the filtered wavelength will not be observed by a user in the field beyond the reticle (3) displaying surface, the focal plane (5), of the optical device since no light at that wavelength from the field beyond the focal plane (5) where the target or other things being observed is getting through the focal plane (5) and back to the observer. Thus, in the preferred embodiment one picks a wavelength that is rarely naturally occurring, for example orange or red. If one then uses a very narrow band pass for the coating filter the observer will still not see red or orange but the observer's eye can't discern that that particular wavelength band is missing.

Increasing the efficiency of the system allows for a lower power consumption since the filtered display brightness does not need to overcome the background brightness hobbled with only 4% reflection.

Since certain changes may be made in the above described filtered projected reticle system of this disclosure without departing from the scope of the invention herein involved, it is intended that all matter contained in the description thereof or shown in the accompanying figures shall be interpreted as illustrative and not in a limiting sense.

What is claimed is:

1. What is claimed is a filtered projected reticle system comprising:
a form of display or illuminating device;
said form of display or illuminating device creating and projecting a reticle onto a focal point on a focal plane of an observational device or riflescope;
said reticle creating and projecting form of display or illuminating device being filtered with a transmission coating filter that limits the spectral emission of said reticle creating and projecting form of display or illuminating device to the transmission specification of said transmission coating filter; and,
said focal plane having a reflecting filter coating placed on said focal plane upon which said reticle creating and projecting form of display or illuminating device reticle is projected and said reflecting coating filter having a reflectivity specification corresponding to said reticle creating and projecting form of display or illuminating device transmission coating filter's transmission specification.

2. The filtered projected reticle system of claim 1 wherein said reflective coating filter can also be placed on a reticle displaying surface instead of said focal plane of said filtered projected reticle system.

3. The filtered projected reticle system of claim 2 wherein said form of display or illuminating device is a Heads-Up Display.

4. The filtered projected reticle system of claim 3 wherein said transmission coating filter and reflecting coating filter are thin film coating filters.
